(19) United States
(12) Patent Application Publication
(10) Pub. No.: US 2014/0015831 A1
(43) Pub. Date: Jan. 16, 2014

(54) APPARATUS AND METHOD FOR PROCESSING MANIPULATION OF 3D VIRTUAL OBJECT

(71) Applicant: Electronics and Telecommunications Research Institude, Daejeon-city (KR)

(72) Inventors: Jin-Woo KIM, Daejeon (KR); Tae-Man HAN, Daejeon (KR); Jee-Sook EUN, Daejeon (KR); Boo-Sun JEON, Daejeon (KR)

(21) Appl. No.: 13/942,078

(22) Filed: Jul. 15, 2013

(30) Foreign Application Priority Data
Jul. 16, 2012 (KR) 10-2012-0077093

(51) Int. Cl. G06F 3/0481

(52) U.S. Cl. CPC G06F 3/04815
USPC 345/419

(57) ABSTRACT

Disclosed herein are an apparatus and method for processing the manipulation of a three-dimensional (3D) virtual object. The apparatus includes an image input unit, an environment reconstruction unit, a 3D object modeling unit, a space matching unit, and a manipulation processing unit. The image input unit receives image information generated by capturing a surrounding environment including a manipulating object. The environment reconstruction unit reconstructs a 3D virtual reality space. The 3D object modeling unit models a 3D virtual object that is manipulated by the manipulating object, and generates a 3D rendering space. The space matching unit matches the 3D rendering space to the 3D virtual reality space. The manipulation processing unit determines whether the manipulating object is in contact with the surface of the 3D virtual object, and tracks the path of a contact point and processes the motion of the 3D virtual object.

### CROSS REFERENCE TO RELATED APPLICATION

This application claims the benefit of Korean Patent Application No. 10-2012-0077093, filed on Jul. 16, 2012, which is hereby incorporated by reference in its entirety into this application.

### BACKGROUND OF THE INVENTION

1. Technical Field

The present invention relates generally to an apparatus and method for processing the manipulation of a three-dimensional (3D) virtual object and, more particularly, to an apparatus and method for processing the manipulation of a 3D virtual object that are capable of providing a user interface that enables a user to manipulate a 3D virtual object in a virtual or augmented reality space by touching it or holding and moving it using a method identical to a method of manipulating an object using the hand or a tool in the real world.

2. Description of the Related Art

Conventional user interfaces (UIs) that are used in 3D television, an augmented reality environment and a virtual reality environment are based on UIs that are used in a 2D plane, and utilize a virtual touch method or a cursor moving method.

Furthermore, in an augmented or virtual reality space, menus are presented in the form of icons, and a higher folder or another screen manages the menus. Furthermore, a lower structure can be viewed by means of a drag-and-drop method or a selection method. However, this conventional technology is problematic in that a two-dimensional (2D) arrangement is used in 3D space or a tool or a gesture detection interface does not surpass the level of simply replacing a remote pointing or mouse function even while in 3D space.

Although Korean Patent Application Publication No. 2009-0056792 discloses technology related to an input interface for augmented reality and an augmented reality system equipped with the input interface, it has its limitation with respect to a user's intuitive manipulation of menus in 3D space.

Furthermore, the technology disclosed in the above patent publication has a problem in that a user cannot intuitively select and execute menus in an augmented or virtual reality environment because it is impossible to execute menus for which a user's gestures can be recognized and classified into a plurality of layers.

### SUMMARY OF THE INVENTION

Accordingly, the present invention has been made keeping in mind the above problems occurring in the prior art, and an object of the present invention is to provide a user interface that enables a user to manipulate a 3D virtual object in a virtual or augmented reality space by touching it or holding and moving it using a method identical to a method of manipulating an object using the hand or a tool in the real world.

Another object of the present invention is to provide a user interface that can conform the sensation of manipulating a virtual object in a virtual or augmented reality space to the sensation of manipulating an object in the real world, thereby imparting intuitiveness and convenience to the manipulation of the virtual object.

Still another object of the present invention is to provide a user interface that can improve a sense of reality that is limited in the case of a conventional command input or user gesture detection scheme that is used to manipulate a virtual object in a virtual or augmented reality space.

In accordance with an aspect of the present invention, there is provided an apparatus for processing manipulation of a 3D virtual object, including an image input unit configured to receive image information generated by capturing a surrounding environment including a manipulating object using a camera; an environment reconstruction unit configured to reconstruct a 3D virtual reality space for the surrounding environment using the image information; a 3D object modeling unit configured to model a 3D virtual object that is manipulated by the manipulating object, and to generate a 3D rendering space including the 3D virtual object; a space matching unit configured to match the 3D rendering space to the 3D virtual reality space; and a manipulation processing unit configured to determine whether the manipulating object is in contact with the surface of the 3D virtual object, and to track a path of a contact point between the surface of the 3D virtual object and the manipulating object and process the motion of the 3D virtual object.

The manipulation processing unit may include a contact determination unit configured to determine that the manipulating object is in contact with the surface of the 3D virtual object if a point on the surface of the manipulating object conforms to a point on the surface of the 3D virtual object in the 3D virtual reality space.

The manipulation processing unit may further include a contact point tracking unit configured to calculate a normal vector directed from the contact point with the surface of the 3D virtual object to a center of gravity of the 3D virtual object and to track the path of the contact point, from a time at which the contact determination unit determines that the manipulating object is in contact with the surface of the 3D virtual object.

The contact point tracking unit may, if the contact point includes two or more contact points, calculate normal vectors with respect to the two or more contact points, and tracks paths of the two or more contact points.

The manipulation processing unit may further include a motion state determination unit configured to determine a motion state of the 3D virtual object by comparing the normal vectors with direction vectors with respect to the paths of the contact points; and the motion state of the 3D virtual object may be any one of a translation motion, a rotation motion or a composite motion in which a translation motion and a rotation motion are performed simultaneously.

The manipulation processing unit may further include a motion processing unit configured to process the motion of the 3D virtual object based on the motion state of the 3D virtual object that is determined by the motion state determination unit.

The apparatus may further include an image correction unit configured to correct the image information so that a field of view of the camera conforms to a field of view of a user who is using the manipulating object, and to acquire information about a relative location relationship between a location of the user's eye and the manipulating object.

The apparatus may further include a manipulation state output unit configured to output the results of the motion of the 3D virtual object attributable to the motion of the manipulating object to a user.

The manipulation state output unit may, if the contact point includes two or more contact points and a distance between the two or more contact points decreases, output information about the deformed appearance of the 3D virtual object to the user based on the distance between the two or more contact points.

In accordance with an aspect of the present invention, there is provided a method of processing manipulation of a 3D virtual object, including receiving image information generated by capturing a surrounding environment including a manipulating object using a camera; reconstructing a 3D virtual reality space for the surrounding environment using the image information; modeling a 3D virtual object that is manipulated by the manipulating object, and generating a 3D rendering space including the 3D virtual object; matching the 3D rendering space to the 3D virtual reality space; and determining whether the manipulating object is in contact with the surface of the 3D virtual object, and tracking a path of a contact point between the surface of the 3D virtual object and the manipulating object and processing the motion of the 3D virtual object.

Processing the motion of the 3D virtual object may include determining that the manipulating object is in contact with the surface of the 3D virtual object if a point on the surface of the manipulating object conforms to a point on the surface of the 3D virtual object in the 3D virtual reality space.

Processing the motion of the 3D virtual object may further include calculating a normal vector directed from the contact point with the surface of the 3D virtual object to a center of gravity of the 3D virtual object and tracking the path of the contact point, from a time at which the contact determination unit determines that the manipulating object is in contact with the surface of the 3D virtual object.

Processing the motion of the 3D virtual object may further include determining whether the contact point includes two or more contact points, and, if the contact point includes two or more contact points, calculating normal vectors with respect to the two or more contact points and tracking paths of the two or more contact points.

Processing the motion of the 3D virtual object may further include determining a motion state of the 3D virtual object by comparing the normal vectors with direction vectors with respect to the paths of the contact points; and the motion state of the 3D virtual object may be any one of a translation motion, a rotation motion or a composite motion in which a translation motion and a rotation motion are performed simultaneously.

Processing the motion of the 3D virtual object may further include processing the motion of the 3D virtual object based on the motion state of the 3D virtual object that is determined by the motion state determination unit.

The method may further include correcting the image information so that a field of view of the camera conforms to a field of view of a user who is using the manipulating object, and acquiring information about a relative location relationship between a location of the user's eye and the manipulating object.

The method may further include outputting the results of the motion of the 3D virtual object attributable to the motion of the manipulating object to a user.

Outputting the results of the motion of the 3D virtual object to the user may be, if the contact point includes two or more contact points and a distance between the two or more contact points decreases, outputting information about the deformed appearance of the 3D virtual object to the user based on the distance between the two or more contact points.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating the configuration of an apparatus for processing the manipulation of a 3D virtual object in accordance with the present invention;

FIG. 2 is a block diagram illustrating the configuration of the manipulation processing unit 600 illustrated in FIG. 1;

FIG. 3 is a diagram illustrating a method of determining whether a manipulating object is in contact with a 3D virtual object using a masking technique;

FIG. 4 is a diagram illustrating a method of determining whether a manipulating object is in contact with a 3D virtual object when there are two or more contact points;

FIG. 5 is a diagram illustrating the translation motion of a 3D virtual object when there is a single contact point;

FIG. 6 is a diagram illustrating the rotation motion of a 3D virtual object when there is a single contact point; and

FIGS. 7 and 8 are flowcharts illustrating a method of processing the manipulation of a 3D virtual object in accordance with the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily vague will be omitted below. The embodiments of the present invention are intended to fully describe the present invention to a person having ordinary knowledge in the art. Accordingly, the shapes, sizes, etc. of elements in the drawings may be exaggerated to make the description clear.

In an apparatus and method for processing the manipulation of a 3D virtual object in accordance with the present invention, a user interface (UI) using a 3D virtual object is based on a user's experience of touching or holding and moving an object that is floating in the air in a gravity-free state in the real world, and can be employed when a user manipulates a virtual 3D object in a virtual or augmented reality environment using an interface that generates visual contact effects.

Furthermore, the concept of an UI that is presented by the present invention provides a user with the sensation of manipulating an object of the actual world in the virtual world by combining the physical concept of the actual object with the 3D information of a 3D model in the virtual world.

Accordingly, in the apparatus and method for processing the manipulation of a 3D virtual object in accordance with the present invention, the UI includes a 3D space adapted to provide a virtual reality environment, and at least one 3D virtual object configured to be represented in a 3D space and to be manipulated in accordance with the motion of a manipulating object, such as a user's hand or a tool, in the real world based on the user's experiences via visual contact effects. Here, to show an augmented or virtual reality environment including a 3D virtual object in a 3D space to a user, the apparatus and method for processing the manipulation of a 3D virtual object in accordance with the present invention may be implemented using a Head Mounted Display (HMD), an Eyeglass Display (EGD) or the like.

The configuration and operation of an apparatus 10 for processing the manipulation of a 3D virtual object in accordance with the present invention will be described below.

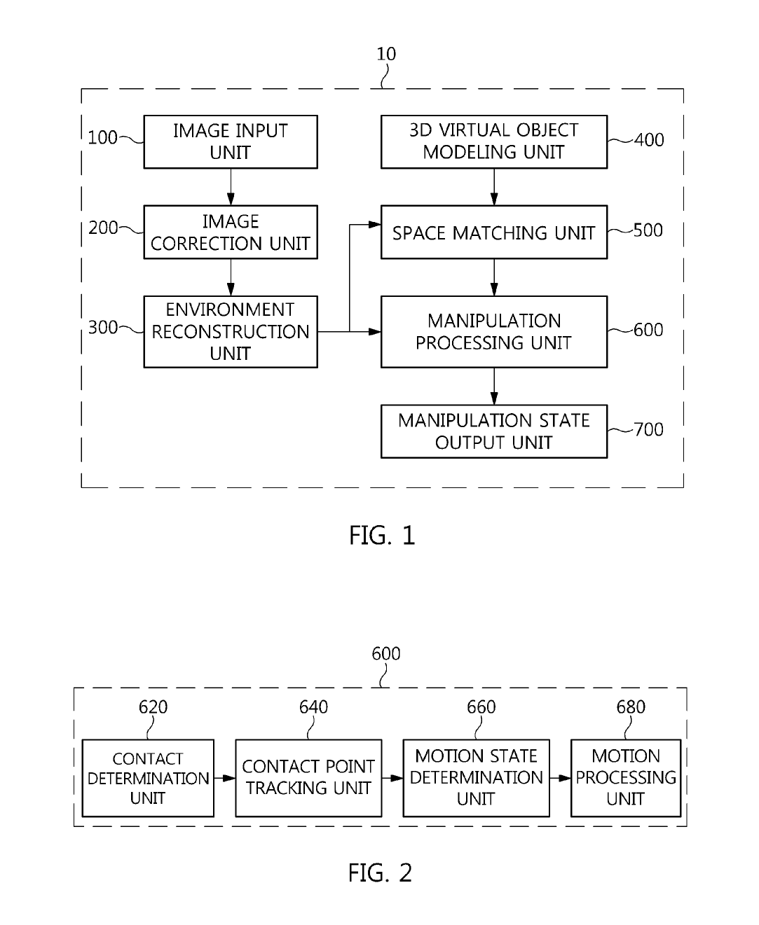

FIG. 1 is a block diagram illustrating the configuration of the apparatus 10 for processing the manipulation of a 3D virtual object in accordance with the present invention.

Referring to FIG. 1, the apparatus 10 for processing the manipulation of a 3D virtual object in accordance with the present invention includes an image input unit 100, an image correction unit 200, an environment reconstruction unit 300, a 3D virtual object modeling unit 400, a space matching unit 500, a manipulation processing unit 600, and a manipulation state output unit 700.

The image input unit 100 receives image information, generated by capturing a manipulating object which is used by a user to manipulate a 3D virtual object and a surrounding environment which is viewed within the user's field of view using a camera, using the camera. Here, the camera that is used to acquire the image information of the manipulating object used by the user and the surrounding environment may be a color camera or a depth camera. Accordingly, the image input unit 100 may receive a color or depth image of the manipulating object and the surrounding environment.

The image correction unit 200 corrects the image information of the manipulating object and the surrounding environment, which are acquired by the camera, so that the field of view of the camera can conform with the field of view of the user who is manipulating the object, thereby acquiring information about the accurate relative location relationship between the location of the user's eye and the manipulating object. The information about the relative location relationship between the acquired location of the user's eye and the manipulating object may be used as information that enables the relative location relationship between the 3D virtual object and the manipulating object to be determined in a 3D virtual reality space to which a 3D rendering space including the 3D virtual object has been matched.

The environment reconstruction unit 300 reconstructs a 3D virtual reality space for a surrounding environment including the manipulating object using the image information input to the image input unit 100. That is, the environment reconstruction unit 300 implements the surrounding environment of the real world in which the user moves the manipulating object in order to manipulate the 3D virtual object in an augmented or virtual reality space, as a virtual 3D space, and determines information about the location of the manipulating object in the implemented virtual 3D space. Here, the manipulating object that is used by the user is modeled as the virtual 3D manipulating object by the environment reconstruction unit 300, and thus the location information the manipulating object in the 3D virtual reality space can be represented by 3D coordinates in accordance with the motion in the real world.

The 3D virtual object modeling unit 400 models the 3D virtual object that is manipulated by the manipulating object used by the user, and generates the virtual 3D rendering space including the modeled 3D virtual object. Here, information about the location of the 3D virtual object modeled by the 3D virtual object modeling unit 400 may be represented by 3D coordinates in the 3D rendering space. Furthermore, the 3D virtual object modeling unit 400 may model the 3D virtual object with the physical characteristic information of the 3D virtual object in a gravity-free state added thereto.

The space matching unit 500 matches the 3D rendering space generated by the 3D virtual object modeling unit 400 to the 3D virtual reality space for the user's surrounding environment reconstructed by the environment reconstruction unit 300, and calculates information about the relative location relationship between the manipulating object in the 3D virtual reality space and the 3D virtual object.

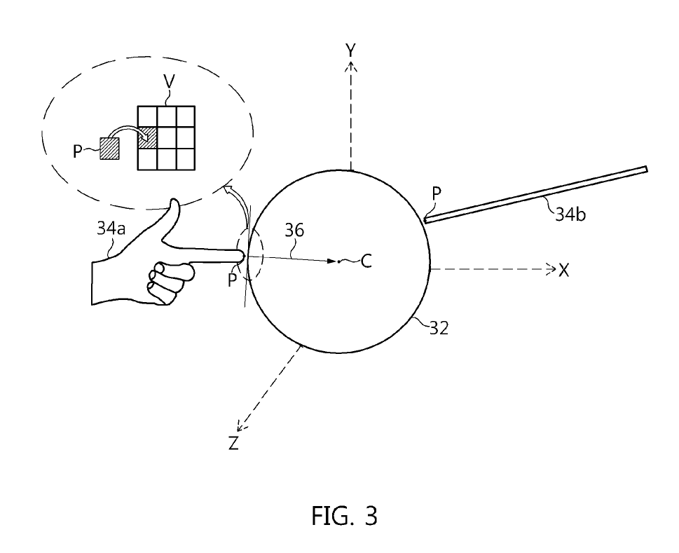

The manipulation processing unit 600 determines whether the manipulating object is in contact with the surface of the 3D virtual object based on the information about the relative location relationship between the manipulating object in the 3D virtual reality space and the 3D virtual object calculated by the space matching unit 500. Furthermore, if it is determined that the manipulating object is in contact with the surface of the 3D virtual object, the manipulation processing unit 600 processes the motion of the 3D virtual object corresponding to the motion of the manipulating object by tracking the path of the contact point between the surface of the 3D virtual object and the manipulating object. The more detailed configuration and operation of the manipulation processing unit 600 will be described later with reference to FIG. 2.

The manipulation state output unit 700 may indicate the 3D virtual reality space matched by the space matching unit 500 and the motions of the manipulating object and the 3D virtual object in the 3D virtual reality space to the user. That is, the manipulation state output unit 700 visually indicates the motion of the 3D virtual object, processed by the manipulation processing unit 600 as the user manipulates the 3D virtual object using the manipulating object, to the user.

FIG. 2 is a block diagram illustrating the configuration of the manipulation processing unit 600 illustrated in FIG. 1.

Referring to FIG. 2, the manipulation processing unit 600 includes a contact determination unit 620, a contact point tracking unit 640, a motion state determination unit 660, and a motion processing unit 680.

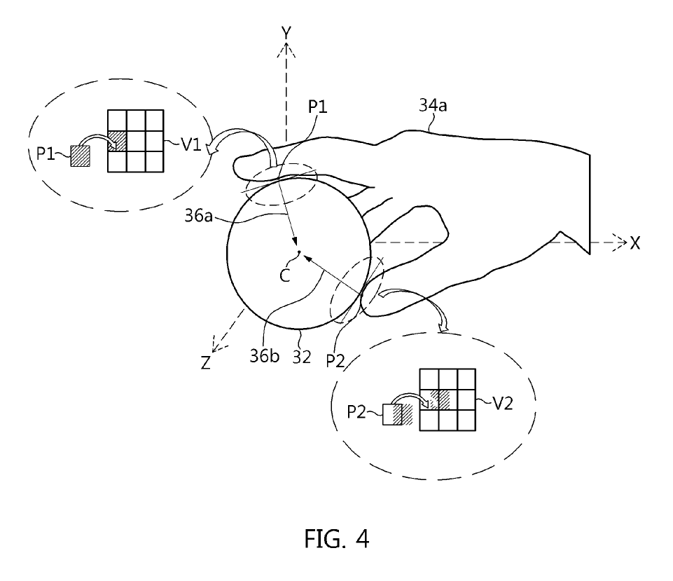

The contact determination unit 620 analyzes the information about the relative location relationship between the manipulating object and the 3D virtual object in the 3D virtual reality space calculated by the space matching unit 500, and, if a point on the surface of the 3D virtual object conforms to a point on the surface of the manipulating object, determines that the manipulating object is in contact with the surface of the 3D virtual object. Here, the contact determination unit 620 implements the surface of the 3D manipulating object and the surface of the 3D virtual object as mask regions composed of regularly sized unit pixels by applying a masking technique to the information about the location of the 3D manipulating object and the information about the location of the 3D virtual object in the 3D virtual reality space. Since the masking technique for representing the surface of a 3D model using a plurality of mask regions is well known in the image processing field, a detailed description thereof will be omitted herein. Referring to FIG. 3, the contact determination unit 620 determines whether a manipulating object 34a or 34b is in contact with the surface of a 3D virtual object 32 by detecting whether a point P on the surface of the manipulating object 34a or 34b has entered the mask region V of the surface of the 3D virtual object 32 and has been included inside a mask of a specific size.

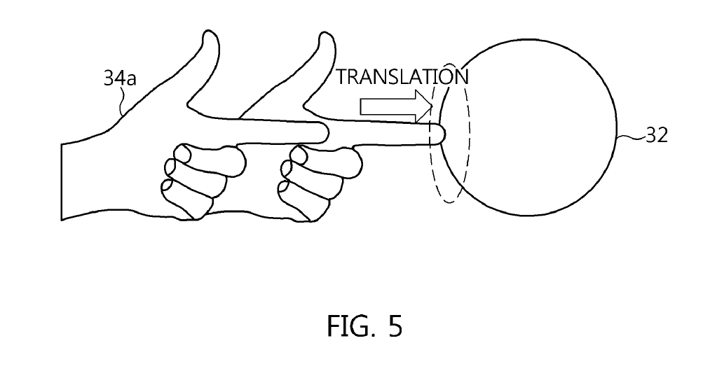

If the contact determination unit 620 determines that the manipulating object 34a or 34b is in contact with the surface of the 3D virtual object 32, the contact point tracking unit 640 calculates a normal vector 36 directed from a contact point with the surface of the 3D virtual object 32 to the center of gravity C of the 3D virtual object 32 and then tracks the path of the contact point. Here, after the manipulating object 34a or 34b has come into contact with the surface of the 3D virtual object 32, the contact point tracking unit 640 calculates the normal vector 36 directed from the contact point between the surface of the 3D virtual object 32 and the manipulating object 34a or 34b to the center of gravity C of the 3D virtual object 32 in real time, and stores it for the duration of specific frames. The stored normal vector 36 may be used as information that is used to track the path of the contact point between the surface of the 3D virtual object 32 and the manipulating object 34a or 34b. Furthermore, the contact point tracking unit 640 may calculate a direction vector with respect to the tracked path of the contact point in real time. Meanwhile, as illustrated in FIG. 4, contact points between the surface of the 3D virtual object 32 and the manipulating object 34a may be two or more in number. This occurs when the user manipulates the 3D virtual object using a tool, such as tongs, as the manipulating object or using two fingers, such as the thumb and the index finger, in order to manipulate the 3D virtual object 32 more accurately. Here, the contact determination unit 620 determines whether the manipulating object 34a is in contact with the surface of the 3D virtual object 32 by detecting whether two or more points P1 and P2 on the surface of manipulating object 34a have entered mask regions V1 and V2 on the surface of the 3D virtual object 32, and have been included as pixel points. Furthermore, the contact point tracking unit 640 calculates normal vectors 36a and 36b with respect to the two or more contact points, and calculates direction vectors by tracking respective paths of the two or more contact points. Here, if a limit related to the defined surface of the 3D virtual object 32 is exceeded because the distance between the two or more contact points decreases while the contact point tracking unit 640 is tracking the respective paths of the two or more contact points, the manipulation state output unit 700 may output information about the deformed appearance of the 3D virtual object 32 to the user. This enables information about the deformation of the appearance of the 3D virtual object 32 attributable to the force that is applied by the user to hold the 3D virtual object 32 when the user holds and carries the 3D virtual object 32 using the manipulating object, to the user as feedback information.

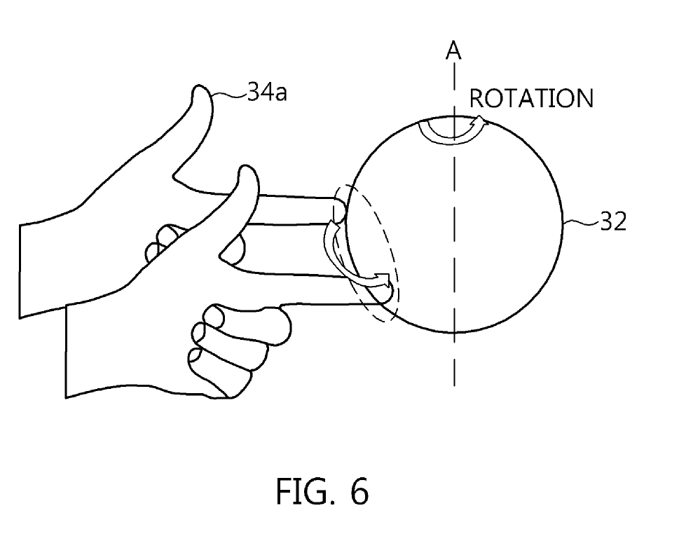

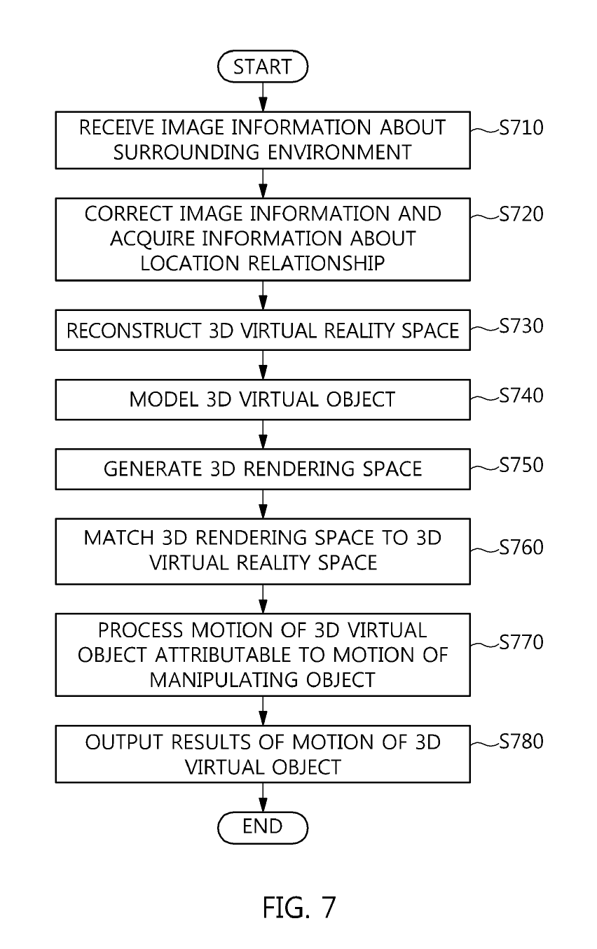

The motion state determination unit 660 determines the motion state of the 3D virtual object 32 by comparing the normal vectors and the direction vectors with respect to the paths of contact points that are calculated by the contact point tracking unit 640 in real time. Here, the motion state of the 3D virtual object 32 determined by the motion state determination unit 660 may be any one of a translation motion, a rotation motion, and a composite motion in which a translation motion and a rotation motion are performed simultaneously. For example, if there is a single contact point, the translation motion of the 3D virtual object 32 may occur, as illustrated in FIG. 5. The translation motion of the 3D virtual object 32, such as that illustrated in FIG. 5, occurs when a direction vector with respect to the path of the contact point and a normal vector 36 directed from the contact point with the surface of the 3D virtual object 32 to the center of gravity C of the 3D virtual object 32 are directed in the same direction. Here, the direction vector with respect to the path of the contact point and the normal vector 36 have the same direction, the motion state determination unit 660 determines the motion state of the 3D virtual object 32 to be a translation motion in the direction of the direction vector with respect to the path of the contact point. In contrast, if there is a single contact point, the rotation motion of the 3D virtual object 32 may occur, as illustrated in FIG. 6. The rotation motion of the 3D virtual object 32 using a specific axis A as the axis of rotation motion, such as that illustrated in FIG. 6 occurs when a direction vector with respect to the path of the contact point and a normal vector 36 directed from the contact point with the surface of the 3D virtual object 32 to the center of gravity C of the 3D virtual object 32 are directed in different directions. Here, if the direction vector with respect to the path of the contact point and the normal vector 36 have the different directions, the motion state determination unit 660 determines the motion state of the 3D virtual object 32 to be a rotation motion. Here, since the axis of rotation motion of the 3D virtual object 32 is not fixed in a gravity-free state, the motion of the 3D virtual object 32 corresponds to a simple rotation motion or a composite motion in which a translation motion and a rotation motion are performed simultaneously depending on the path of the contact point. Whether a motion state in question is a rotation motion or a composite motion in which a translation motion and a rotation motion are performed simultaneously is determined based on the physical characteristics of the 3D virtual object 32 in a gravity-free state and laws of motion. Meanwhile, when a user desires to manipulate an object actually in a gravity-free state using a manipulating object having a single contact point, such as a single finger or a rod, it is difficult to move the object unless the direction of motion of the manipulating object accurately conforms to the center of gravity of the object. In order to overcome this problem, even when a manipulating object having a single contact point is used, the motion of the virtual object 32 can be easily achieved by taking into account the physical characteristics of the 3D virtual object 32 in a gravity-free state in a virtual or augmented reality environment and applying a specific margin for the center of gravity. Accordingly, if the 3D virtual object 32 has a spherical shape, the user can move the 3D virtual object 32 in a desired direction even when he or she does not accurately move the manipulating object in a direction toward the center of gravity of the 3D virtual object 32.

The motion processing unit 680 processes the motion of the 3D virtual object 32 corresponding to the motion of the manipulating object 34a or 34b based on the motion state 3D of the virtual object 32 determined by the motion state determination unit 660. A specific motion that is processed with respect to the 3D virtual object 32 may be any one of a translation motion, a simple rotation motion, and a composite motion in which a translation motion and a rotation motion are performed simultaneously. Here, the motion processing unit 680 may process the motion of the 3D virtual object 32 in accordance with the speed, acceleration and direction of motion of the manipulating object 34a or 34b while applying the virtual coefficient of friction of the 3D virtual object 32. The motion processing unit 680 may use an affine transformation algorithm corresponding to a translation motion, a simple rotation motion or a composite motion in order to process the motion of the 3D virtual object 32.

A method of processing the manipulation of a 3D virtual object in accordance with the present invention will be described below. In the following description, descriptions that are identical to those of the operation of the apparatus for processing the manipulation of a 3D virtual object in accordance with the present invention given in conjunction with FIGS. 1 to 6 will be omitted.

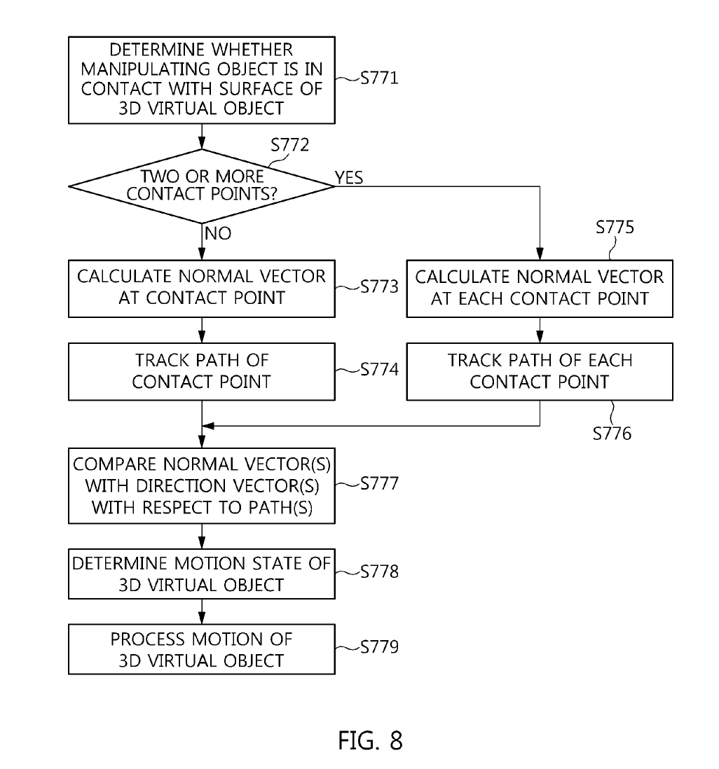

FIG. 7 is a flowchart illustrating the method of processing the manipulation of a 3D virtual object in accordance with the present invention.

Referring to FIG. 7, in the method of processing the manipulation of a 3D virtual object in accordance with the present invention, the image input unit 100 receives image information generated by capturing a surrounding environment including a manipulating object using a camera at step S710. Here, the manipulating object is a tool that is used by a user in the real world in order to modulate the 3D virtual object. The manipulating object may be, for example, the user's hand or a rod, but is not particularly limited thereto.

Furthermore, the image correction unit 200 corrects the image information of the surrounding environment including the manipulating object acquired by the camera so that the field of view of the camera conforms to the field of view of the user who is using the manipulating object, thereby acquiring information about the relative location relationship between the location of the user's eye and the manipulating object at step S720.

Thereafter, at step S730, the environment reconstruction unit 300 reconstructs a 3D virtual reality space for the surrounding environment including the manipulating object using the image information corrected at step S720.

Meanwhile, the 3D virtual object modeling unit 400 models the 3D virtual object that is manipulated in accordance with the motion of the manipulating object that is used by the user at step S740, and creates a 3D rendering space including the 3D virtual object at step S750. Here, steps S740 to S750 of modeling a 3D virtual object and generating a 3D rendering space may be performed prior to steps S710 to S730 of receiving the image information of the surrounding environment including the manipulating object and reconstructing a 3D virtual reality space, or may be performed in parallel with steps S710 to S730.

Thereafter, the space matching unit 500 matches the 3D rendering space generated by the 3D virtual object modeling unit 400 to the 3D virtual reality space for the user's surrounding environment reconstructed by the environment reconstruction unit 300 at step S760. Here, the space matching unit 500 may calculate information about the relative location relationship between the manipulating object and the 3D virtual object 3D in the virtual reality space.

Thereafter, the manipulation processing unit 600 determines whether the manipulating object is in contact with the surface of the 3D virtual object based on the information about the relative location relationship between the manipulating object and the 3D virtual object in the 3D virtual reality space calculated by the space matching unit 500, and tracks the path of a contact point between the surface of the 3D virtual object and the manipulating object, thereby processing the motion of the 3D virtual object attributable to the motion of the manipulating object at step S770.

Finally, the manipulation state output unit 700 outputs the results of the motion of the 3D virtual object attributable to the motion of the manipulating object to the user at step S780. At step S780, if contact points between the surface of the 3D virtual object and the manipulating object are two or more in number and the distance between the two or more contact points decreases, the manipulation state output unit 700 may output information about the deformed appearance of the 3D virtual object to the user based on the distance between the contact points.

FIG. 8 is a flowchart illustrating step S770 of processing the motion of the 3D virtual object attributable to the motion of the manipulating object illustrated in FIG. 7 in greater detail.

Referring to FIG. 8, once at step S760, the space matching unit 500 has matched the 3D rendering space generated by the 3D virtual object modeling unit 400 to the 3D virtual reality space for the user's surrounding environment reconstructed by the environment reconstruction unit 300 and has calculated information about the relative location relationship between the manipulating object and the 3D virtual object 3D in the virtual reality space, the contact determination unit 620 determines whether the manipulating object is in contact with the surface of the 3D virtual object in the 3D virtual reality space at step S771. Whether the manipulating object is in contact with the surface of the 3D virtual object determined at step S771 is determined by determining whether a point on the surface of the 3D virtual object conforms to a point on the surface of the manipulating object in the 3D virtual reality space.

Furthermore, if it is determined at step S771 that the manipulating object is in contact with the surface of the 3D virtual object in the 3D virtual reality space step, the contact point tracking unit 640 determines whether contact points between the surface of the 3D virtual object and the manipulating object are two or more in number at step S772.

If, as a result of the determination at step S772, it is determined that the contact points between the surface of the 3D virtual object and the manipulating object are not two or more in number, the contact point tracking unit 640 calculates a normal vector directed from a contact point with the surface of the 3D virtual object to the center of gravity of the 3D virtual object at step S773, and tracks the path of the contact point, from the time at which the contact determination unit 620 determines that the manipulating object is in contact with the surface of the 3D virtual object, at step S774.

In contrast, if, as a result of the determination at step S772, it is determined that the contact points between the surface of the 3D virtual object and the manipulating object are two or more in number, the contact point tracking unit 640 calculates a normal vector directed from each of the contact points with the surface of the 3D virtual object to the center of gravity of the 3D virtual object at step S775, and tracks the path of each of the contact points, from the time at which the contact determination unit 620 determines that the manipulating object is in contact with the surface of the 3D virtual object, at step S776.

Thereafter, the motion state determination unit 660 determines the motion state of the 3D virtual object at step S778 by comparing the normal vector or normal vectors calculated at steps S773 and S774 or at steps S775 and S776 with a direction vector or direction vectors for the tracked path or paths of the contact point or contact points and then making an analysis thereof at step S777. Here, the motion state of the virtual object determined at step S778 may be any one of a translation motion, a rotation motion, and a composite motion in which a translation motion and a rotation motion are performed simultaneously.

Furthermore, at step S779, the motion processing unit 680 processes the motion of the 3D virtual object corresponding to the motion of the manipulating object based on the motion state of the 3D virtual object determined at step S778. Here, the motion processing unit 680 may process the motion of the 3D virtual object in accordance with the speed, acceleration and direction of motion of the manipulating object while applying the virtual coefficient of friction of the 3D virtual object.

In accordance with an aspect of the present invention, there is provided a user interface that enables a user to manipulate a 3D virtual object by touching it or holding and moving it using a method identical to a method of manipulating an object using a hand or a tool in the real world.

In accordance with another aspect of the present invention, there is provided a user interface that can conform the sensation of manipulating a virtual object in a virtual or augmented reality space to the sensation of manipulating an object in the real world, thereby imparting intuitiveness and convenience to the manipulation of the virtual object.

In accordance with a still another aspect of the present invention, there is provided a user interface that can improve a sense of reality that is limited in the case of a conventional command input or user gesture detection scheme that is used to manipulate a virtual object in a virtual or augmented reality space.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for processing manipulation of a three-dimensional (3D) virtual object, comprising:
an image input unit configured to receive image information generated by capturing a surrounding environment including a manipulating object using a camera;
an environment reconstruction unit configured to reconstruct a 3D virtual reality space for the surrounding environment using the image information;
a 3D object modeling unit configured to model a 3D virtual object that is manipulated by the manipulating object, and to generate a 3D rendering space including the 3D virtual object;
a space matching unit configured to match the 3D rendering space to the 3D virtual reality space; and
a manipulation processing unit configured to determine whether the manipulating object is in contact with a surface of the 3D virtual object, to track a path of a contact point between the surface of the 3D virtual object and the manipulating object, and to process a motion of the 3D virtual object.

2. The apparatus of claim 1, wherein the manipulation processing unit includes a contact determination unit configured to determine that the manipulating object is in contact with the surface of the 3D virtual object if a point on the surface of the manipulating object conforms to a point on the surface of the 3D virtual object in the 3D virtual reality space.

3. The apparatus of claim 2, wherein the manipulation processing unit further includes a contact point tracking unit configured to calculate a normal vector directed from the contact point with the surface of the 3D virtual object to a center of gravity of the 3D virtual object and to track the path of the contact point, from a time at which the contact determination unit determines that the manipulating object is in contact with the surface of the 3D virtual object.

4. The apparatus of claim 3, wherein the contact point tracking unit, if the contact point includes two or more contact points, calculates normal vectors with respect to the two or more contact points, and tracks paths of the two or more contact points.

5. The apparatus of claim 4, wherein:
the manipulation processing unit further includes a motion state determination unit configured to determine a motion state of the 3D virtual object by comparing the normal vectors with direction vectors with respect to the paths of the contact points; and
the motion state of the 3D virtual object is any one of a translation motion, a rotation motion or a composite motion in which a translation motion and a rotation motion are performed simultaneously.

6. The apparatus of claim 5, wherein the manipulation processing unit further includes a motion processing unit configured to process the motion of the 3D virtual object based on the motion state of the 3D virtual object that is determined by the motion state determination unit.

7. The apparatus of claim 1, further comprising an image correction unit configured to correct the image information so that a field of view of the camera conforms to a field of view of a user who is using the manipulating object, and to acquire information about a relative location relationship between a location of the user's eye and the manipulating object.

8. The apparatus of claim 1, further comprising a manipulation state output unit configured to output results of the motion of the 3D virtual object attributable to a motion of the manipulating object to a user.

9. The apparatus of claim 8, wherein the manipulation state output unit, if the contact point includes two or more contact points and a distance between the two or more contact points decreases, outputs information about a deformed appearance of the 3D virtual object to the user based on the distance between the two or more contact points.

10. A method of processing manipulation of a 3D virtual object, comprising:
receiving image information generated by capturing a surrounding environment including a manipulating object using a camera;
reconstructing a 3D virtual reality space for the surrounding environment using the image information;
modeling a 3D virtual object that is manipulated by the manipulating object, and generating a 3D rendering space including the 3D virtual object;
matching the 3D rendering space to the 3D virtual reality space; and
determining whether the manipulating object is in contact with a surface of the 3D virtual object, tracking a path of a contact point between the surface of the 3D virtual object and the manipulating object, and processing a motion of the 3D virtual object.

11. The method of claim 10, wherein processing the motion of the 3D virtual object includes determining that the manipulating object is in contact with the surface of the 3D virtual object if a point on the surface of the manipulating object conforms to a point on the surface of the 3D virtual object in the 3D virtual reality space.

12. The method of claim 11, wherein processing the motion of the 3D virtual object further includes calculating a normal vector directed from the contact point with the surface of the 3D virtual object to a center of gravity of the 3D virtual object and tracking the path of the contact point, from a time at which the contact determination unit determines that the manipulating object is in contact with the surface of the 3D virtual object.

13. The method of claim 12, wherein processing the motion of the 3D virtual object further includes determining whether the contact point includes two or more contact points, and, if the contact point includes two or more contact points, calculating normal vectors with respect to the two or more contact points and tracking paths of the two or more contact points.

14. The method of claim 13, wherein:
processing the motion of the 3D virtual object further includes determining a motion state of the 3D virtual object by comparing the normal vectors with direction vectors with respect to the paths of the contact points; and
the motion state of the 3D virtual object is any one of a translation motion, a rotation motion or a composite motion in which a translation motion and a rotation motion are performed simultaneously.

15. The method of claim 14, wherein processing the motion of the 3D virtual object further includes processing the motion of the 3D virtual object based on the motion state of the 3D virtual object that is determined by the motion state determination unit.

16. The method of claim 10, further comprising correcting the image information so that a field of view of the camera conforms to a field of view of a user who is using the manipulating object, and acquiring information about a relative location relationship between a location of the user's eye and the manipulating object.

17. The method of claim 10, further comprising outputting results of the motion of the 3D virtual object attributable to a motion of the manipulating object to a user.

18. The method of claim 17, wherein outputting the results of the motion of the 3D virtual object to the user is, if the contact point includes two or more contact points and a distance between the two or more contact points decreases, outputting information about a deformed appearance of the 3D virtual object to the user based on the distance between the two or more contact points.
